(19) United States
(12) Patent Application Publication
(10) Pub. No.: US 2014/0201206 A1
(43) Pub. Date: Jul. 17, 2014

(54) Global Deployment of Analytical Methods Via Networked Database to Mobile (Smart Phone) Technology

(71) Applicant: Symbion Systems, Inc., Irvine, CA (US)

(72) Inventor: Michael A. Power, Irvine, CA (US)

(73) Assignee: Symbion Systems, Inc., Irvine, CA (US)

(21) Appl. No.: 14/154,124

(22) Filed: Jan. 13, 2014

Related U.S. Application Data
(60) Provisional application No. 61/751,706, filed on Jan. 11, 2013.

(51) Int. Cl. G06F 17/30

(52) U.S. Cl. CPC G06F 17/30595
USPC 707/736

(57) ABSTRACT

a method for global deployment of analytical methods and merging of data via mobile technology and remote mobile devices, the method comprising: developing analytical methods for quantification and identification to be stored in a relational database and distributed to remote mobile devices; developing execution methods to be stored in a relational database and distributed to remote mobile devices; employing a methodology incorporating gatekeeper applications to ensure full control and traceability in the development, deployment, and use of the analytical methods and the processing and distribution of data and analytical predictions; collecting field data from remote devices to a central relational database for a posterior analysis, model enhancement, and archiving; providing remote distributed access to all stored data including field data and processed data; providing a database methodology that provides for a highly level of security for the transmission of data and the storage of data; and providing a robust networking strategy to accommodate for potentially unreliable and unstable network connections

This patent application claims, pursuant to 35 USC 119, the benefit of the priority date of U.S. Provisional Patent Application Ser. No. 61/751,706, filed on Jan. 11, 2013 and entitled GLOBAL DEPLOYMENT OF ANALYTICAL METHODS VIA NETWORKED DATABASE TO SMART PHONE TECHNOLOGY. The entire contents of this provisional patent application are hereby expressly incorporated by reference.

### FIELD OF THE INVENTION

The present invention relates generally to process control equipment and methodology. The present invention relates more particularly to a system for the global deployment of analytical methods via mobile (smart phone and tablet) technology.

### BACKGROUND OF THE INVENTION

Although the prior art has recognized, to a limited extent, the problem of controlling processes from diverse locations with respect to measurement devices (such as spectrometers) and control devices (such as flow control valves) (see e.g. application Ser. No. 10/832,001, filed Apr. 26, 2004, the entire contents of which are hereby incorporated by reference as if fully set forth herein), the known systems to date have not addressed the global deployment of analytical methods to mobile (smart phone and tablet) technology.

### BRIEF SUMMARY OF THE INVENTION

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The present invention specifically addresses and alleviates the above mentioned deficiencies associated with the prior art. More particularly, the present invention comprises a method for global deployment of analytical methods and merging of data via mobile technology and remote mobile devices, the method comprising: developing analytical methods for quantification and identification to be stored in a relational database and distributed to remote mobile devices; developing execution methods to be stored in a relational database and distributed to remote mobile devices; employing a methodology incorporating gatekeeper applications to ensure full control and traceability in the development, deployment, and use of the analytical methods and the processing and distribution of data and analytical predictions; collecting field data from remote devices to a central relational database for a posterior analysis, model enhancement, and archiving; providing remote distributed access to all stored data including field data and processed data; providing a database methodology that provides for a highly level of security for the transmission of data and the storage of data; and providing a robust networking strategy to accommodate for potentially unreliable and unstable network connections.

These, as well as other advantages of the present invention, will be more apparent from the following description and drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

FIG. 1 illustrates a preferred embodiment of the system and related method;

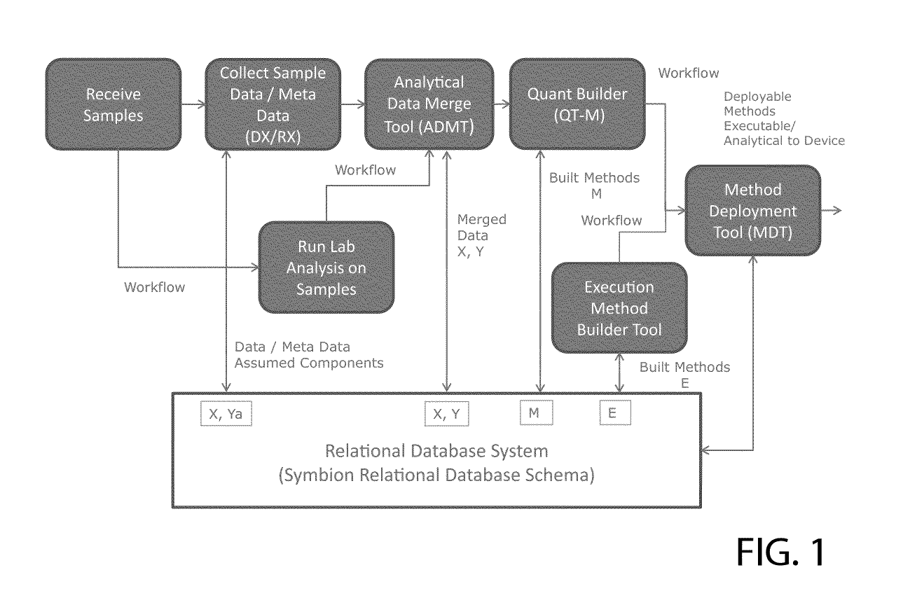

FIG. 2 describes the integration of secure and reliable remote communications via mobile database connectivity; and

FIG. 3 describes the details of the mobile database schema.

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

### Introduction

Symbion ADMT is a proposed system for the global deployment of analytical methods via mobile (smart phone and tablet) technology. The key to the system is the use of a relational database for deployment in a highly-distributed network environment and additional components fundamental to the current Symbion RX analytical instrumentation software. In addition to these, ADMT will employ elements that are specific to the distributed smart phone environment. These include an Execution Method Developer (EMD), a Method Deployment Tool (MDT), a Smart Phone Configuration Tool (SPCT), and an Access Control Tool (ACT). Together, these elements comprise a system for the wide scale deployment of methods for material identification and quantification. The system can be employed in conjunction with robust and light weight spectrometers as well as other analytical instruments. Application areas include but are not limited to pharmaceutical drying and blending, food and beverage QA, homeland security, law enforcement, and the military.

### Functional Elements

The operation of the ADMT system incorporates the following functions:

1. The development analytical methods for quantification and identification to be stored in a relational database and distributed to remote smart phone or tablet based field devices.

2. The development of execution methods to be similarly stored and distributed.

3. The employment of a methodology incorporating gatekeeper applications to ensure full control and traceability in the development, deployment, and use of analytical methods and the processing and distribution of data and analytical predictions.

4. The collection of field data from remote devices to a central relational database for a posterior analysis, model enhancement, and archiving.

5. Remote distributed access to all stored data including field data and processed data.

6. A database methodology that provides for a highly level of security for the transmission of data and the storage of data.

7. A robust networking strategy to accommodate for potentially unreliable and unstable network connections.

### Description of Workflow

The main steps in the operation of the ADMT system are outlined below:

1. Receive and Prepare Samples for Calibration:

Obtain and prepare samples to be used for calibration purposes.

a. Create samples with and assign sample names (Xname)

b. Determine assumed component values (Ya) for samples in X.

c. If exact components value are known from samples in X, skip Step 2.

2. Obtain Exact Sample Component Data:

If component values of received samples are not know, transfer samples to a central laboratory to quantify samples. Laboratory will provide exact values for each desired component.

a. For each sample in X determine the associated component values (Y).

b. Provide components values for Step 4.

3. Collection and Storage of Sample Instrument Data and Meta Data:

Run Symbion DX/RX software to obtain calibration data (X) for each sample Xname by using an analytical device essentially identical to the ones to be deployed in the field. Symbion DX/RX can store additional meta data and associated the meta data in the relational database. Sample meta data may include but is not limited to the following:

a. Sample name (Xname as in Step 1)

b. Sample ID (bar code, ID number, etc.)

c. Deployed process

d. Timestamp

e. Author (user)

f. Acquisition parameters

g. Sample conditions, if known (Temperature, pressure, etc.)

h. Instrument information (Serial number, model number, probe temp, etc.)

i. Stored using current user and group associations to limit/control access to stored spectral data and meta data.

4. Merge Sample Instrument Data and Sample Component Data:

The Symbion Analytical Data Merge Tool (ADMT) will provide this function. Login into Symbion Analytical Data Merge Tool (ADMT) to associate instrument data X with laboratory analysis of components Y (e.g., PETN, HCL, etc). The ADMT tool will store the data X, Y and associations into the database.

5. Analytical Model Development:

The data from step 4 will be loaded into the Symbion QT chemometric model builder to synthesize analytical models M from instrument data X and exact component values Y. The Symbion QT model builder provides the following capabilities:

a. The Symbion QT data parsing module extracts the required instrument data X and component data Y from the database and automatically builds the data table needed for chemometric model development.

b. The analyst employs Symbion QT to build appropriate models for the identification and/or quantification of sample analytes using field deployed analytical devices.

c. Symbion QT generates an object (M) which contains all the information necessary to
i. Identify and/or quantify analytes over the entire range of instrument operation,
ii. Provide identification/quantification metrics to assess the quality of the resulting identification/quantification,
iii. Embed the run-time executable object for target architecture of remote deployment. The embedded object can run the defined quantification method on the target device.

d. Finally, Symbion QT stores the object M in the relational database using the Symbion RDBS schema.

6. Creation of a Deployable Execution Method:

This step will be accomplished by an Execution Method Developer (EMD) specifically designed for smart phone deployment. The EMD application creates pre-configured executable functions that can run on a remote device. The functions are bundled and stored as a complete executable method (E) in the database. The functions that can be assembled and deployed as a fully functional execution method on any given remote device The basic set of functions are comprised of:

a. Deployed analytical method (M) from Symbion QT,

b. Intended user interface to be shown on the deployed smart-phone device from Symbion EMD including indicators, trends and controls,

c. Specification of the store and forward parameters for the transfer of spectral and trend data to the centralized RDBS,

d. Meta data, including author, time stamp, and deployed process

7. Storage of the Execution Method:

The execution method E is to be stored into the database so that the remote deployment tool can transfer the execution method along with any quantitative models (M) to a mobile device.

8. Remote Deployment:

The Symbion Method Deployment Tool (MDT) will enable identification, quantification, and execution methods to be deployed to a given smart phone or to a group of smart phone devices. MDT login is controlled by obtaining user permissions from Symbion relational database using the Symbion RDBS schema.

9. Analysis of Field Samples:

Once the executable and quantification methods have been deployed, the field operator will be able to run execution models E deposited into the internal database of the deployed devise in order to identify and/or quantify unknown samples using the specified portable analytical device.

10. Local Storage and Forwarding:

The system provides for storage of all collected data in a local database and subsequent transmission to the central database whenever a suitable communication link is available.

11. On the Fly Model Enhancement:

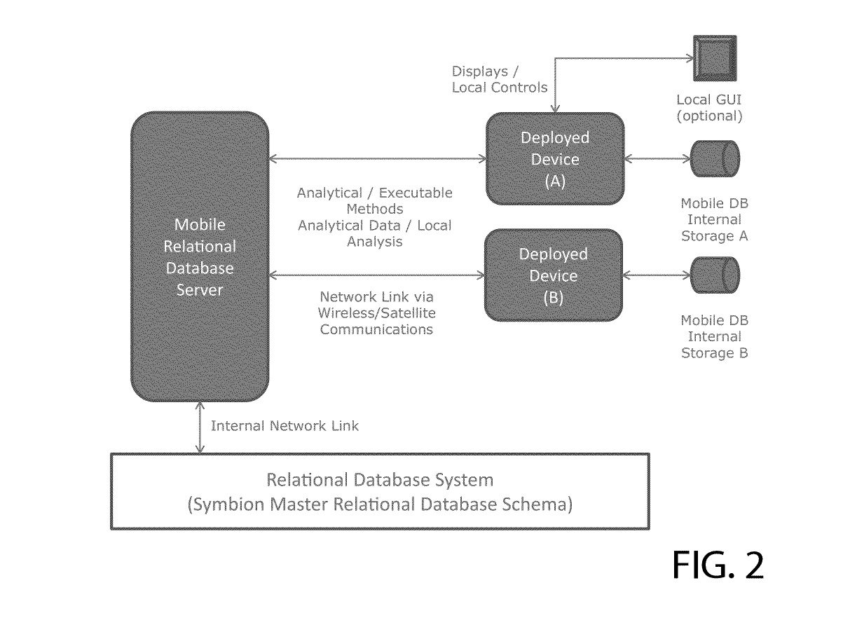

Analytical models can be enhanced by incorporating data collected in the field. The data from the field samples will be transmitted back to central database, as in FIG. 2, and available for new model development. An analytical model can be updated and re-deposited onto the remote deployed device using the MDT application. Thus allowing for coordinated, controlled and automated on-the-fly model enhancement.

### Description of Secure and Reliable Database Integration

FIG. 2 describes the integration of secure and reliable remote communications via mobile database connectivity.

### Security and Data Integrity Aspects

The remote devices will be operating in zones where network connectivity may be highly unreliable (manufacturing floor, law enforcement applications, homeland security, etc.) and there is the potential risk for tampering and/or intentional intrusion of the data and/or data stream (combat zone, falsifying data records, etc.) Thus, there is a need for a mobile client/server pair, as in FIG. 2, that can accommodate for this type of environment.
1. The local server/client pair will provide data integrity checks for potentially corrupted data streams arriving from the remote field devices. If the data is received in a corrupted fashion, the data will be re-transmitted until the received data is correct.
2. The data stream and the client/server databases will provide for a high level of encryption for over-the-air data transmission and secure local access of the device in case there is an attempt to access the data in an unauthorized fashion.
3. All local spectral data and processed data will be forwarded to the mobile server and then on to the master Symbion relational database using stand database replication methodologies as network connectivity permits. Only one data record for a given sample can exist at any time across all databases (master, mobile server database, client database). In case of unauthorized intrusion of a deployed mobile device, the locally collected data is automatically uploaded off the local database.

### Downloaded Data (Execution and Analytical Methods)

The execution and analytical methods will be built using the EMD and MDT tools respectively and stored to the master Symbion relational database schema. These control objects will be downloaded to the deployed devise(s) remotely via the MDT application. The application will send a request to the mobile server to populate the desired execution and quant methods onto the targeted mobile device(s). The mobile server caches the requests and as network access permits downloads the methods into the appropriate mobile remote device database.

### Uploaded Data

Locally collected instrument data and instrument meta data (as in Step 3) are automatically uploaded to the master Symbion database via the mobile server along with the local analytical results and analytical meta data (goodness of fit, F-test, etc.)

### Description of Mobile Database Schema

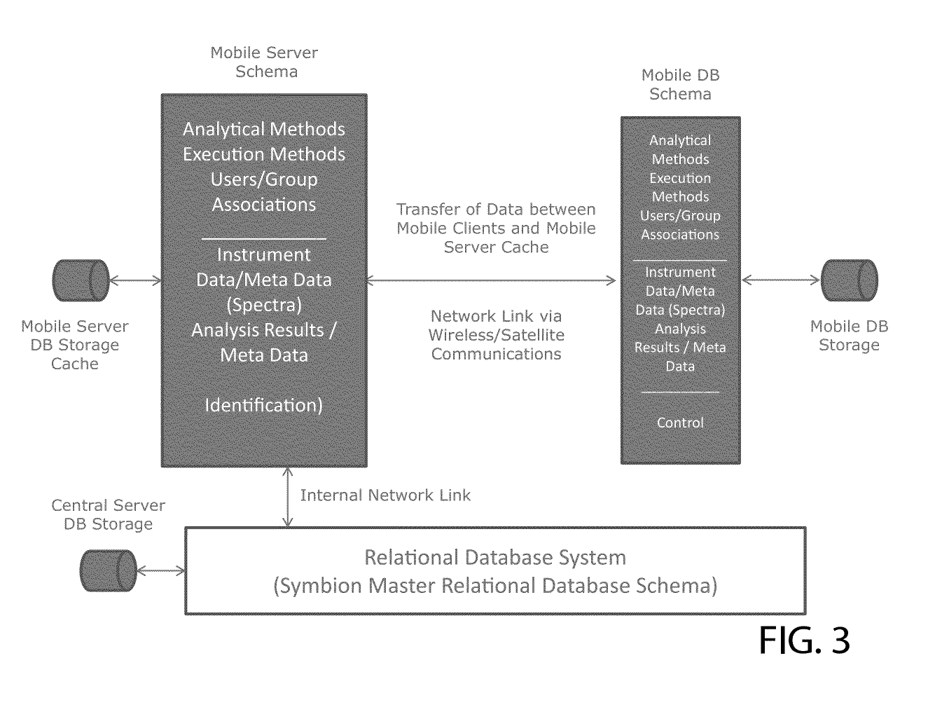

FIG. 3 describes the details of the mobile database schema

### Database Schema Elements

The mobile database schema is to provide:

1. Storage of execution methods (E)

2. Storage of analytical methods (M)

3. Local Storage of spectral data and meta data (X)

4. Local storage of analytical results (Yhat)

5. User and Group associations for limiting and controlling access.

### Local Control

The mobile database schema for the client will differ slightly form the server. The mobile database schema for the client will also include database tables for local control information. This provides a mechanism for the locally installed apps (M and E) to pass control, status and data information to each other.

### Additional Applications

### Establishment of Deployment Groups

The Smart Phone Configuration Tool (SPCT) sets up a given mobile device or a group of mobile devices as a deployment unit/group. This deployment group is used in the MDT application so that a set of devices can be targeted and configured as a group rather than individually configured.

### Establishment of User Names and Passwords

The Symbion Access Control Tool (ACT) configures and controls the username/password pairs and groups across all applications. By writing to the Symbion relational database schema, access can be selectively provided to individual modules such as:
Symbion DX/RX
Symbion Insight-MB
Symbion DMT
Symbion EMD
Symbion MDT
Symbion SPCT
Symbion ACT

Thus, these and other modifications and additions may be obvious to those skilled in the art and may be implemented to adapt the present invention for use in a variety of different applications.

We claim:

1. A method for global deployment of analytical methods and merging of data via mobile technology and remote mobile devices, the method comprising:
developing analytical methods for quantification and identification to be stored in a relational database and distributed to remote mobile devices;
developing execution methods to be stored in a relational database and distributed to remote mobile devices;
employing a methodology incorporating gatekeeper applications to ensure full control and traceability in the development, deployment, and use of the analytical methods and the processing and distribution of data and analytical predictions;
collecting field data from remote devices to a central relational database for a posterior analysis, model enhancement, and archiving;
providing remote distributed access to all stored data including field data and processed data;
providing a database methodology that provides for a highly level of security for the transmission of data and the storage of data; and
providing a robust networking strategy to accommodate for potentially unreliable and unstable network connections.

2. The method of claim 1 wherein the remote mobile devices comprise smart phone and tablet based field devices.
